(19) United States
(12) Patent Application Publication
(10) Pub. No.: US 2011/0197507 A1
(43) Pub. Date: Aug. 18, 2011

(54) PLANTING MEDIA FOR ROOFTOP GARDENS

(76) Inventor: Grant Cameron, Richmond (CA)

(21) Appl. No.: 12/705,256

(22) Filed: Feb. 12, 2010

(51) Int. Cl. A01G 31/00; A01G 9/02; C05F 11/00

(52) U.S. Cl. 47/59 S; 71/27

(57) ABSTRACT

A light weight plant growth medium for use in rooftop gardens or other above-ground planting installations where minimal weight is desirable comprises a mixture of crumb rubber and an organic material suitable for plant growth. A system for providing a rooftop with a garden comprises a plurality of containers containing such a growth medium, each said container being open at the top and having a flat bottom provided with drainage holes and water retention areas to maintain the nourishment and watering of plants in the growth medium.

### FIELD OF THE INVENTION

This invention relates to novel plant growth media, particularly for use in rooftop applications and other above-ground planting areas such as planter boxes, where light weight, adequate drainage and sustainability are of critical importance.

### BACKGROUND OF THE INVENTION AND PRIOR ART

Roof gardens and various structural components for soil and plant containers for that purpose are well known. There are numerous prior art patents and applications for different apparatus for roof garden systems, including modules, panels and other forms of container of different types claiming a variety of useful innovative features such as ease of installation, improved air flow and/or water retention and drainage, and pre-seeded panels.

We recognized that a major shortcoming of conventional planting media, such as those including gravel for drainage, is excessive weight of the planting mixture. This is especially a problem in above-ground applications such as flower boxes where gravitational structural stress should be kept to a minimum. We sought to provide a planting medium which would exhibit improved aeration and drainage and be light, easy to use, cheap, readily available and environmentally friendly (recyclable) for use in green roof applications.

### SUMMARY OF THE INVENTION

With a view to achieving the aforementioned advantages we have utilized crumb rubber as a major component in rooftop soil compounds resulting in a high quality soil for plant growth which can be formulated with organic matter (soil) to provide a product which is up to 47% lighter than currently available alternative soil products used in rooftop gardens. Optimum performance results have been found for a mix of fine ground tire rubber and ZEBA™ planting soil made by Ero-soil in an approximately 1:1 mixture by volume. In what follows, growing media according to the invention will be collectively referred to as “Green Roof Soil”.

According to a particular aspect of the invention there is provided a system for laying out rooftop gardens in which green roof oil is used in combination with special light weight plastic containers (preferably high molecular weight polyethylene) configured to allow areas of water retention and areas of water drainage for an optimum growing environment.

### DESCRIPTION OF THE DRAWING

FIG. 1 is a schematic representation in a perspective view of from above of a rectangular container for green rooftop soil and seed material suitable for assembly into a rooftop garden array;

FIG. 2 is a top plan view thereof; and

FIG. 3 is a side sectional view thereof.

### DETAILED DESCRIPTION OF THE INVENTION

Green Root Soil according to the invention consists of an equivolume mixture of commercially prepared compost with crumbed tire rubber having a granule size between ⅛ inch and ⅜ inches. This material is of a low density, reducing the weight on the rooftop compared with other systems and affords superior drainage. Both the compost and the tire rubber crumb are available with relative ease and are locally supplied. Modular containers of Green Root Soil mixture can easily be charged and planted at ground level then transported to their location in the system array.

The use of crumb rubber derived from automobile tires is consistent with good recycling practice and there is no shortage of this raw material.

Crumb rubber is readily available commercially in ⅜ inch and ½ inch crumb sizes. Produced from tire rubber, it qualifies as a practical recycling product, and there is little or no shortage of raw materials. Such crumb rubber is conventionally used as a component in solid form with other components in a variety of landscaping applications, such as for pathways, mulches, etc. but has not hitherto been mixed with soil as a planting medium for roof gardens, where its property is conduced to significant advantages.

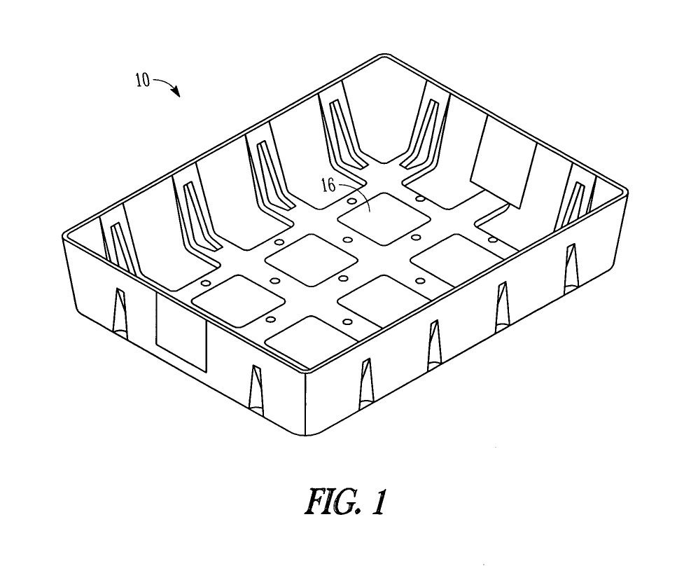

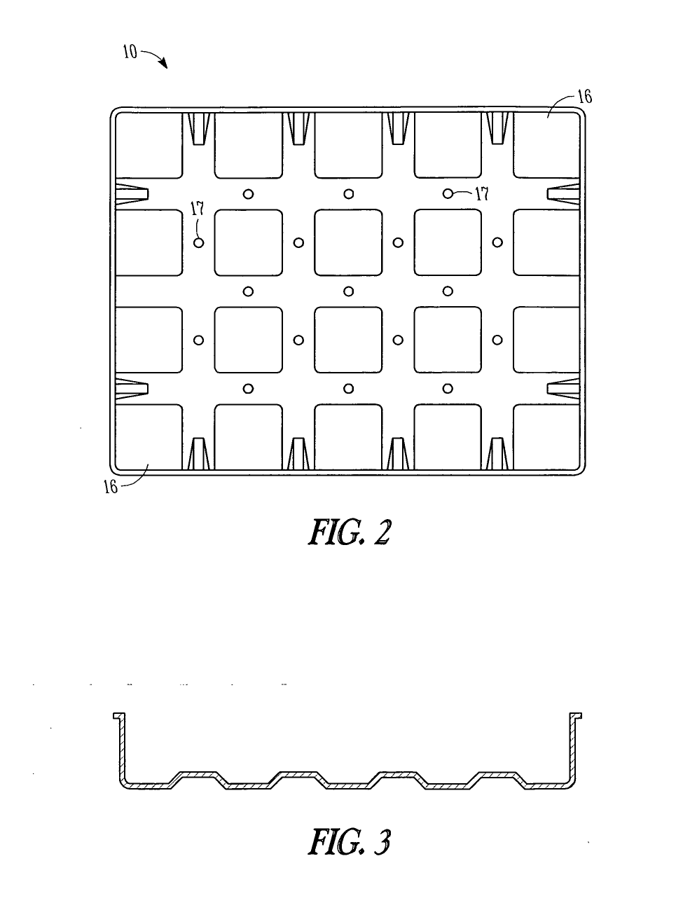

In a green roof system prepared according to the invention and successfully tested for performance and aesthetic character (in an area of high visibility), applicant's growth medium Crystal Light™ Soil”, a blend of organic and inorganic components was charged into modular trays 10 as illustrated in FIGS. 1 to 3. The dimension of each tray was 1.5 feet by 2 feet by 4 inches depth. A drainage clearance of 0.5 inches above the roof was provided for. Containers 10 are formed of 150 mil recycled (100% pre-consumer) high molecular weight polyethylene, protected with UV inhibitors and stabilizers. The module colour was black.

The modules are arranged contiguously side to side and end to end in an array and may be used in conjunction with conventional waterproofing systems for roof gardens, such as single-ply EPDM, TPO, PVC membrane systems or other roof membranes. Module 10 is formed with end and side handles 12 and 14 and are embossed to present alternating water retention areas 16 and drainage holes 17. Optionally, a filter or fabric drainage material may be added to the crystal light soil, such as unbonded polypropylene geotextile.

Planter modules according to the invention are relatively light weight and easy to use in both rooftop and window box applications. Any incidental damage to plants installed in these containers in use (by chimney workers or window cleaners, for example) can be easily repaired by lifting the box from its site for repair or recharging. Where there is degradation with time of the compost component of the Green Roof Soil, as there typically will be with any compost-containing planting mixture, refreshment/refurbishment of the unit can be attained by top-dressing with replacement compost.

Other light weight inorganic additives have been added to soil to produce potting media, such as pumice, but this material is more difficult to work with, presents sharp edges which can injure seedlings and is not a recycled product. In addition, use of pumice in rooftop garden applications would entail added expense in transporting and mixing the growing medium components.

Appended to this description of the invention are three pages of tabular and graphical results showing the composition and properties of one Green Roof Soil planting medium as determined in an experimental analysis carried out at the Agricultural Analytical Services Laboratory of the Pennsylvania State University. Page 1 relating to an analysis of the composition and certain physical properties of the sample and pages 2 and 3 providing the particle size distribution.

Although the invention has been described in connection with a particular embodiment, it will be understood that variations can be made which do not depart from the spirit of the invention which is the implementation of the new concept of using crumb rubber in rooftop soil compounds to produce a high quality soil for plant growth which is up to 47% lighter than conventional soil products used in rooftop gardens.

I claim:

1. A plant growth medium for use in rooftop gardens or other above-ground planting installations, comprising an intimate mixture of approximately equal amounts by volume of crumb rubber and an organic material to sustain plant growth.

2. A plant growth medium according to claim 1, wherein said crumb rubber has an average particle diameter of between ⅜ inch and ½ inch.

3. A plant growth medium according to claim 2, wherein said organic material is topsoil or a component of topsoil.

4. A plant growth medium according to claim 2, wherein said organic material is ZEBATM™ planting soil.

5. An organic medium according to claim 1, further comprising a minor portion of filter or fabric drainage material.

6. A plant growth medium according to claim 5, wherein said filter or fabric drainage material is made of spun bonded polypropylene geotextile.

7. A system for providing a rooftop with a garden, comprising a plurality of contiguous rectangular containers containing a growth medium according to claim 1, each said container being open at the top and having a flat bottom provided with drainage holes and water retention areas to maintain the nourishment and watering of plants seeded or transplanted into said growth medium.

8. A system according to claim 7, wherein each said container is formed of a light weight structural plastic.

9. A system according to claim 8, wherein each said container is provided with integral handle formations at the ends and/or sides thereof for ready transportation of the container to or from said plurality of containers.
